(19) United States
(12) Patent Application Publication
(10) Pub. No.: US 2012/0253842 A1
(43) Pub. Date: Oct. 4, 2012

(54) METHODS, APPARATUSES AND COMPUTER PROGRAM PRODUCTS FOR GENERATING AGGREGATED HEALTH CARE SUMMARIES

(75) Inventors: Charles Lamar Curran, Pinole, CA (US); Ronald L. Cordell, Emeryville, CA (US)

(73) Assignee: McKesson Financial Holdings

(21) Appl. No.: 13/074,892

(22) Filed: Mar. 29, 2011

(51) Int. Cl. G06Q 50/00

(52) U.S. Cl. 705/3

(57) ABSTRACT

An apparatus is provided for generating one or more patient health care summary documents. The apparatus may include at least one memory and at least one processor configured to receive medical information, associated with one or more patients, from one or more different health care entities. The processor is also configured to identify one or more unique codes from the received medical information. The unique codes may correspond to code terminologies related to one or more types of medical data. The processor is also configured to generate a patient health care summary document(s), corresponding to a patient, in response to receipt of a request from at least one health care entity. The patient health care summary document may be generated based in part on at least one of the code terminologies determined to be utilized by the health care entity. Corresponding computer program products and methods are also provided.

### TECHNOLOGICAL FIELD

Embodiments of the invention relate generally to a mechanism of generating one or more patient health care summary documents, and more particularly relate to a method, apparatus and computer program product for generating one or more patient health care summary documents for communication with one or more health care entities.

### BACKGROUND

Currently, elements of a patient's health record may be scattered throughout many documents across many different environments. At present, health care systems may utilize continuity of care documents (CCDs) to provide a summary of patient specific data containing clinical, demographic, and administrative data for a particular patient. The continuity of care documents may be clinical documents for exchange among health care systems. One drawback of current health care systems utilizing continuity of care documents is that the nature of CCD exchange amongst different document entities and consumers may involve the exchange of many documents causing an inefficient method for health care providers to review a patient's health record.

In this regard, in order to obtain a complete record of a patient's health information, a user may be required to import multiple documents from different entities. The multiple documents may be coded with relevant medical information about a patient. However, the different coding systems that the documents are coded with may cause a loss of fidelity in the data that is being exchanged. In many cases, mapping data between different coding systems may result in many choices and the health care systems typically have to make choices that may lead to some loss of fidelity when importing the data in a continuity of care document. This may cause an undesirable drawback resulting in a given context of care having incomplete or inaccurate information or an inefficient process of duplicating reconciliation processes at multiple health care entities. Additionally, at present, there may be no easy way for health care providers to review this scattered information.

Current solutions to this scattered information problem may involve health record aggregation. However, existing health record aggregation approaches are typically inefficient and costly. In this regard, for example, faxing health records between health care entities to aggregate health records may be inefficient and costly. Additionally, for example, leveraging Healthcare Information Technology Standards Panel (HITSP) and Integrating the Healthcare Enterprise (IHE) standards for exchanging health documents may be inefficient since the approaches of these standards typically do not properly address the need to receive one document with current information relating to a particular patient that may be coded with terminologies that a health care entity requesting the health documents may utilize as discrete health care data.

In view of the foregoing drawbacks, it may be beneficial to provide an efficient and reliable mechanism of generating one or more patient health care documents in which the data of the documents may be aggregated from multiple sources and coded with terminologies that a requesting health care system may understand and utilize.

### BRIEF SUMMARY

A method, apparatus and computer program product are therefore provided that may enable the provision of an efficient and reliable mechanism for generating one or more patient health care documents for communication with one or more health care entities. In this regard, an example embodiment may generate the patient health care documents based in part on a code terminology utilized by one or more health care entities or systems requesting the patient health care documents.

In this manner, a system (e.g., health care system) of an exemplary embodiment may include a communication device configured to receive discrete medical information from one or more different health care entities or health care sources. The medical information may be aggregated by the communication device and the communication device may determine that the medical information relates to one or more corresponding patients.

In response to receipt of a request from a device of a health care entity requesting a patient health care document corresponding to a particular patient, the communication device may, but need not, generate the patient health care summary based in part on one or more coding terminologies utilized by the requesting health care entity. In addition, the generated patient health care document may exclude medical information that may be designated as private. The medical information may be designated as private by a corresponding patient(s) or by one or more health care entities on behalf of a patient(s). The communication device may send the generated patient health care document to the requesting health care entity. In this manner, the communication device may ensure that a device of the requesting health care entity may utilize and understand or recognize the medical information of the generated patient health care document.

As such, an example embodiment may generate patient health care document documents that may be unique to the health care entity requesting the patient health care document and which may exclude medical information that a patient may wish to remain private.

In one exemplary embodiment, a method for generating one or more patient health care summary documents is provided. The method may include receiving medical information, associated with one or more patients. The medical information may be received from one or more different health care entities. The method may further include identifying one or more unique codes from the received medical information. The unique codes may correspond to one or more code terminologies related to one or more types of medical data. The method may further include generating at least one patient health care summary document, corresponding to a patient, in response to receipt of a request from at least one of the health care entities. The patient health care summary document may be generated based in part on at least one of the code terminologies determined to be utilized by the at least one health care entity.

In another exemplary embodiment, an apparatus for generating one or more patient health care summary documents is provided. The apparatus may include a memory and a processor configured to cause the apparatus to receive medical information, associated with one or more patients. The medical information may be received from one or more different health care entities. The processor is further configured to cause the apparatus to identify one or more unique codes from the received medical information. The unique codes may correspond to one or more code terminologies related to one or more types of medical data. The processor is further configured to cause the apparatus to generate at least one patient health care summary document, corresponding to a patient, in response to receipt of a request from at least one of the health care entities. The patient health care summary document may be generated based in part on at least one of the code terminologies determined to be utilized by the at least one health care entity.

In another exemplary embodiment, a computer program product for generating one or more patient health care summary documents is provided. The computer program product includes at least one computer-readable storage medium having computer-executable program code instructions stored therein. The computer-executable program code instructions may include program code instructions configured to facilitate receipt of medical information, associated with one or more patients. The medical information may be received from one or more different health care entities. The computer program product may further include program code instructions configured to identify one or more unique codes from the received medical information. The unique codes may correspond to one or more code terminologies related to one or more types of medical data. The computer program product may further include program code instructions configured to generate at least one patient health care summary document, corresponding to a patient, in response to receipt of a request from at least one of the health care entities. The patient health care summary document may be generated based in part on at least one of the code terminologies determined to be utilized by the at least one health care entity.

Embodiments of the invention may provide a method, apparatus and computer program product for enabling an efficient and reliable mechanism for generating patient health care documents based in part on a coding terminology utilized by a requesting health care entity. As a result, health care entities may receive an accurate, complete and recognizable patient health care document in an efficient and reliable manner.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of a communication device according to an exemplary embodiment of the invention;

FIG. 3 is a schematic block diagram of a computing device according to an exemplary embodiment of the invention;

FIGS. 4A & 4B are diagrams of patient health care documents according to an exemplary embodiment of the invention;

FIGS. 5A, 5B & 5C are diagrams of patient health care documents according to another exemplary embodiment of the invention;

FIGS. 6A, 6B & 6C are diagrams of patient health care documents according to another exemplary embodiment of the invention; and

FIG. 7 is a flowchart of an exemplary method for generating one or more patient health care documents according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a patient health care document(s) (also referred to herein as a patient health care summary document(s)) may be a continuity of care document (CCD) which may conform to an Extensible Markup Language (XML)-based markup standard and may be utilized to specify the encoding, structure and semantics of a patient summary clinical document for exchange. The data of the patient summary may include, but is not limited to, the most current administrative, demographic, clinical information, insurance information, diagnosis, health problems, medications, allergies and care plan information associated with a patient's healthcare relative to one or more health care encounters. The patient health care document(s) may include a textual part and optional structured parts (e.g., for software processing). The structured parts may be based on the health level seven (HL7) standard and may provide a framework for referring to concepts from coding systems, which may include, but are not limited to, Systematized Nomenclature of Medicine (SNOMED) coding systems, Logical Observation Identifiers Names and Codes (LOINC) coding systems, International Statistical Classification of Diseases and Related Health Problems (ICD) 9 (ICD-9) coding systems and any other suitable coding systems.

### General System Architecture

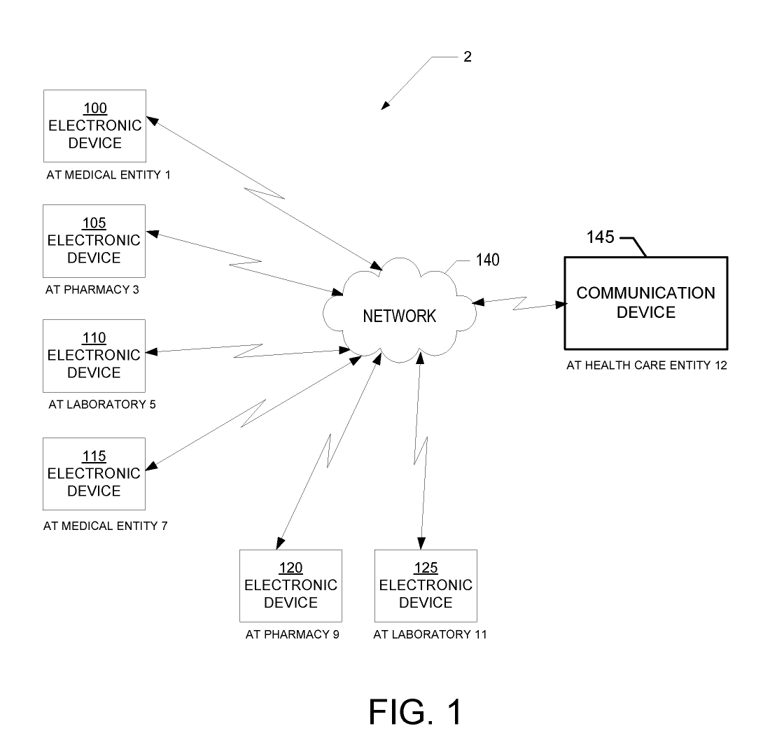

Reference is now made to FIG. 1, which is a block diagram of a system according to exemplary embodiments. As shown in FIG. 1, the system 2 (e.g., a health care system) may include one or more electronic devices 100, 105, 110, 115, 120 and 125 (e.g., personal computers, laptops, workstations, servers, personal digital assistants, smart devices and the like, etc.) which may access one or more network entities such as, for example, a communication device 145 (e.g., a server), or any other similar network entity, over a network 140, such as a wired local area network (LAN) or a wireless local area network (WLAN), a metropolitan network (MAN) and/or a wide area network (WAN) (e.g., the Internet). In this regard, the communication device 145 is capable of receiving data from and transmitting data to the electronic devices 100, 105, 110, 115, 120 and 125 via network 140.

In one exemplary embodiment, the electronic devices 100, 105, 110, 115, 120 and 125 may be utilized by clinicians, nurses, pharmacists, physicians, physical therapists and/or any other suitable health care professionals. In another exemplary embodiment, one or more of the electronic devices 100, 105, 110, 115, 120, 125 may be utilized by one or more patients. The electronic devices 100, 105, 110, 115, 120, 125 may be maintained by one or more health care institutions. For instance, the electronic device 100 may be maintained by a medical entity 1, the electronic device 105 may be maintained by a pharmacy 3 (e.g., Surescripts™), the electronic device 110 may be maintained by a laboratory 5. Additionally, the electronic device 115 may be maintained by a medical entity 7, the electronic device 120 may be maintained by a pharmacy 9 and the electronic device 125 may be maintained by the laboratory 11. In an exemplary embodiment, the communication device 145 may be maintained by a health care entity 12. In an alternative exemplary embodiment, the communication device 145 may be maintained by any other suitable entity.

The communication device 145 may communicate with the electronic devices 100, 105, 110, 115, 120, 125. In this regard, the communication device 145 may receive medical information from and may transmit medical information to the electronic devices 100, 105, 110, 115, 120, 125. The medical information may be utilized by the communication device 145 to generate one or more patient health care documents. Each of the patient health care documents may be associated with a respective patient. The patient health care documents may be generated based in part on the aggregated medical information received from one or more of the electronic devices 100, 105, 110, 115, 120 and 125, as described more fully below. The aggregated medical information may be associated with respective patients.

It should be pointed out that although FIG. 1 shows six electronic devices 100, 105, 110, 115, 120, 125 and one communication device 145 any suitable number of electronic devices 100, 105, 110, 115, 120, 125 and communication devices 145 may be part of the system of FIG. 1 without departing from the spirit and scope of the invention. As an example, a user (e.g., a patient or other individual, etc.) may utilize an electronic device to communicate with the communication device 145 to access or obtain a patient health care summary document(s) generated by the communication device 145 that may be associated with a particular patient.

### Communication Device

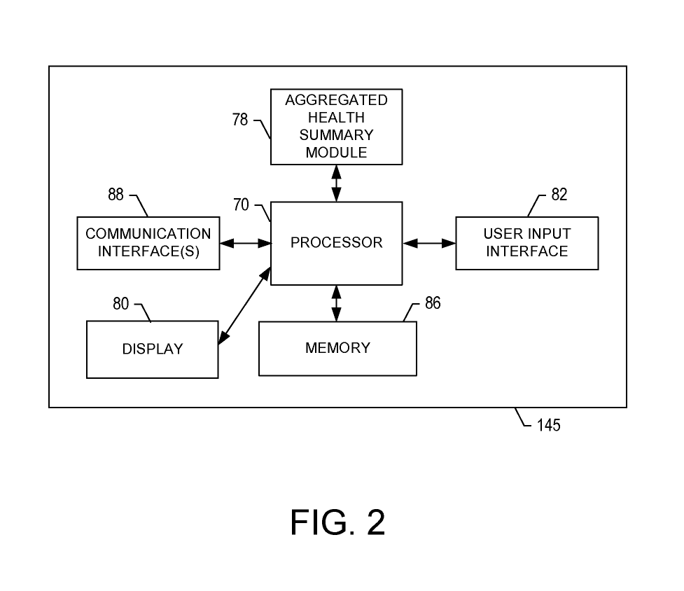

FIG. 2 illustrates a block diagram of a communication device according to an exemplary embodiment of the invention. The communication device 145 may, but need not, be a network entity such as, for example, a server. The communication device 145 includes various means for performing one or more functions in accordance with exemplary embodiments of the invention, including those more particularly shown and described herein. It should be understood, however, that one or more of the communication devices may include alternative means for performing one or more like functions, without departing from the spirit and scope of the invention. More particularly, for example, as shown in FIG. 2, the communication device 145 may include a processor 70 connected to a memory 86. The memory may comprise volatile and/or non-volatile memory, and typically stores content (e.g., media content, medical information, etc.), data, information or the like.

For example, the memory may store content transmitted from, and/or received by, the electronic devices 100, 105, 110, 115, 120 and 125. In this regard, in an exemplary embodiment, the memory 86 may store data received from various disparate sources. For example, the memory 86 may store medical information received by the communication device 145 from the electronic devices of the medical entity 1, the pharmacy 3, the laboratory 5, the medical entity 7, the pharmacy 9 and the laboratory 11, etc. The medical information may include medical diagnoses, laboratory results, medical tests or measurements, medical chart information (e.g., clinician assessments, vital signs, etc.), prescription data, medical imaging data (e.g., X-rays of the human body), alert information and any other suitable information.

The medical information associated with the medical diagnoses, laboratory results, medical tests or measurements, medical chart information, prescription data, medical image data and alert information may also include data corresponding to dates and times this information was created or the actual dates and times of actual events (e.g., actual date and time of a laboratory result) associated with the generation of this information. Additionally, the medical information may also include, but is not limited to, data associated with admission of a patient into a medical institution and a corresponding date and time of discharge of a patient from a medical facility.

Additionally, the medical information may include, but is not limited to, one or more medical events or procedures (e.g., surgical procedures) and may indicate one or more dates and times of these events or procedures, transfers from different medical units (e.g., critical to telemetry, critical to medical surgery (Med-Surg), telemetry to critical, etc.) within a facility (e.g., hospital) and corresponding date and times of such transfer(s), expected or forecasted discharge dates and times, tasks that remain unmet, one or more pre-admission events and corresponding dates and times as well as any other suitable medical information.

The medical information received by the communication device 145 from the electronic devices 100, 105, 110, 115, 120, 125 may include one or more unique patient identifiers. The patient identifiers may identify respective patients. In an example embodiment, the patient identifiers may be one or more unique alphanumeric characters used to denote the identity of respective patients. For instance, a patient identifier such as, for example, 07GHI243 may identify a patient such as, for example, John Doe (e.g., a fictitious person as referred to herein). In an example embodiment, Medical Record Numbers (MRNs) may be utilized as patient identifiers to identify corresponding patients. Additionally, or alternatively, patient demographic data (e.g., biographical data (e.g., name, date of birth, etc.), gender, race, age, etc.) may be utilized to determine the identity of one or more patients.

Also for example, the memory 86 typically stores client applications, instructions, algorithms or the like for execution by the processor 70 to perform steps associated with operation of the communication device 145 in accordance with embodiments of the invention. As explained below, for example, the memory 86 may store one or more client applications such as for example software (e.g., software code also referred to herein as computer code).

The processor 70 may be embodied in a variety of ways. For instance, the processor 70 may be embodied as a controller, coprocessor, microprocessor of other processing devices including integrated circuits such as, for example, an application specific integrated circuit (ASIC), a field programmable gate array (FPGA). In an exemplary embodiment, the processor may execute instructions stored in the memory 86 or otherwise accessible to the processor 70.

The communication device 145 may include one or more logic elements for performing various functions of one or more client applications. In an exemplary embodiment, the communication device 145 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other devices such as, for example, electronic devices 100, 105, 110, 115, 120, 125 over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface can support a wired connection with the respective network.

In addition to the communication interface(s), the interface(s) may also include at least one user interface that may include one or more earphones and/or speakers, a display 80, and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control an aggregated health summary module 78. The aggregated health summary module 78 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the aggregated health summary module 78, as described below. In examples in which software is employed, a device or circuitry (e.g., processor 70 in one example) executing the software forms the structure associated with such means. As such, for example, the aggregated health summary module 78 may be configured to, among other things, generate one or more patient health care documents based in part on aggregated data received from multiple different entities/sources such as the electronic devices 100, 105, 110, 115, 120, 125 maintained respectively by the medical entity 1, the pharmacy 3, the laboratory 5, the medical entity 7, the pharmacy 9 and the laboratory 11, as described more fully below.

The patient health care documents, generated by the aggregated health summary module 78, may be unique or specific to a health care entity (e.g., a health care system) requesting the patient health care document(s) and may include the most current information relating to a corresponding patient taking into account the patient's privacy wishes. The aggregated health summary module 78 may populate some of the data of the patient health care document(s) with one or more coding terminologies utilized by the health care entity requesting the patient health care document(s) to enable the health care entity to understand and utilize the medical data of the patient health care documents.

The aggregated health summary module 78 may generate a patient health care document(s) based in part on medical information associated with a corresponding patient that the aggregated health summary module 78 may receive from one or more various different entities or sources (e.g., medical entity 1, pharmacy 3, laboratory 5, medical entity 7, pharmacy 9, laboratory 11, etc.) as well as based on medical information associated with the patient obtained from the health care entity 12. The aggregated health summary module 78 may determine that the medical information is associated with a corresponding patient based on a patient identifier in the medical information. In this manner, the patient identifier may identify the corresponding patient, as described above.

The aggregated health summary module 78 may receive the medical information, utilized to generate the patient health care documents, from one or more different entities or sources (e.g., medical entity 1, pharmacy 3, laboratory 5, medical entity 7, pharmacy 9, laboratory 11, etc.) automatically in response to the electronic devices of the entities/sources determining that data (e.g., existing data or new data) associated with a corresponding patient is available.

In an example embodiment, the aggregated health summary module 78 may receive a request or message from one or more of the electronic devices 100, 105, 110, 115, 120, 125 requesting a patient health care document(s) for a corresponding patient(s) (e.g., John Doe). In response to receipt of the request, the communication device 145 may generate the patient health care document(s) based in part on one or more coding terminologies of medical data received by the communication device 145 from an electronic device (e.g., electronic device 100). The received medical data may correspond to the particular patient(s) (e.g., John Doe). In this regard, the aggregated health summary module 78 may send the generated patient health care document(s) to the requesting electronic device (e.g., electronic device 100) of a health care entity, as described more fully below.

### Computing Device

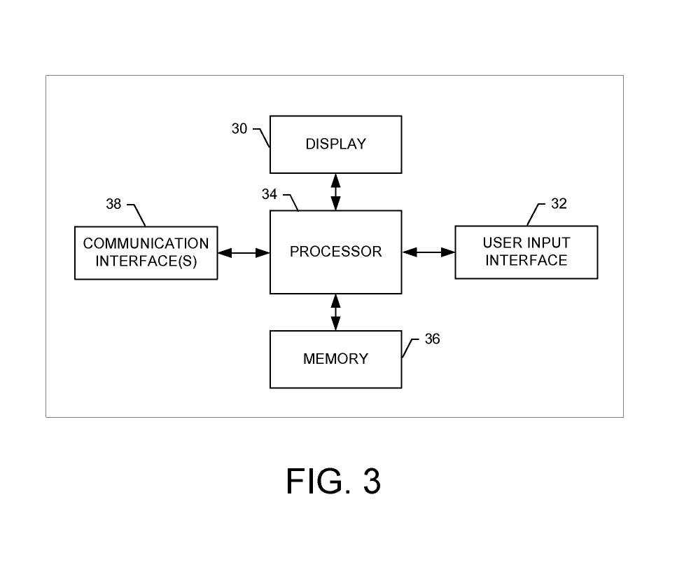

Referring now to FIG. 3, a block diagram of a computing device according to an exemplary embodiment is provided. The computing device is capable of operating as any of electronic devices 100, 105, 110, 115, 120 and 125. In this regard, the electronic devices 100, 105, 110, 115, 120, and 125 may comprise the elements of the computing device of FIG. 3. As shown in FIG. 3, the computing device may include a processor 34 connected to a memory device 36. The memory device 36 (also referred to herein as memory 36) may comprise volatile and/or non-volatile memory, and may store content, information, data or the like. For example, the memory device 36 typically stores content transmitted from, and/or received by, the computing device. Additionally, the memory device 36 may store client applications, software (e.g., software code) algorithms, instructions or the like for the processor 34 to perform steps associated with operation of the computing device.

The memory device 36 may store medical information (e.g., medical diagnoses, laboratory results, medications, etc.) associated with one or more patients. The medical information may include one or more patient identifiers identifying respective patients (e.g., John Doe). The medical information may also include one or more codes that may be defined to designate and identify medical data. For instance, the unique codes may designate and identify specific diseases (e.g., diabetes), diagnoses, injuries, conditions, types of medications (e.g., a class of antidepressants), medications (e.g., amoxicillin), types of laboratory results and any other suitable medical data. In an exemplary embodiment, at least some of the codes may be International Statistical Classification of Diseases and Related Health Problems (ICD) 9 (ICD-9) codes which may classify diseases, a variety of signs, symptoms, abnormal findings, complaints, causes of injury or disease, social circumstances and any other suitable health care data. In this regard, health conditions may be assigned a unique category and a code (e.g., six characters in length, or any other suitable length).

Additionally, in an exemplary embodiment, some of the unique codes may also be Logical Observation Identifiers Names and Codes (LOINC), which may relate to HL7, and/or Systematized Nomenclature of Medicine (SNOMED) codes. The LOINC and SNOMED codes which may be codes utilized to designate and identify diseases, diagnoses, injuries, medical conditions, types of medications, medications, types of laboratory results and any other suitable medical data.

In an instance in which medical information that may include the codes may be sent to the communication device 145, by the processor 34, the aggregated health summary module 78 may detect a code(s) and may analyze data of the detected code(s) to determine whether the code(s) relates to diseases, diagnoses, injuries, medical conditions, medications, laboratory results and any other suitable medical data for a corresponding patient(s).

The processor 34 may be connected to at least one communication interface 38 or other means for displaying, transmitting and/or receiving data, content, information or the like. In this regard, the communication interface 38 may be capable of connecting to one or more networks. The computing device may also include at least one user input interface 32 that may include one or more speakers, a display 30, and/or any other suitable devices. For instance, the user input interface 32 may include any of a number of devices allowing the computing device to receive data from a user, such as a keyboard, a keypad, mouse, a microphone, a touch screen display or any other input device.

The processor 34 may send medical information associated with one or more patients to the communication device 145 in response to determining that medical information is available for corresponding patients. In an example embodiment, the processor 34 may automatically send medical information associated with one or more patients to the communication device 145 in response to determining that medical information for a patient(s) is available. The processor 34 may determine that medical information is available in response to determining that medical data associated with a patient identifier(s) or demographics data identifying a patient(s) is stored in a memory (e.g., memory device 36). In this regard, when the processor 34 detects newly stored data, in the memory, that is associated with a patient(s), the processor 34 may automatically send the data to the communication device 145.

In an example embodiment, in an instance in which the processor 34 may send medical information associated with a patient(s) to the communication device 145, the medical information may include information that is designated as private. In this regard, the aggregated health summary module 78 may determine that information designated as private may not be shared with any health care entity (e.g., medical entity 1, pharmacy 3, laboratory 5, medical entity 7, pharmacy 9, laboratory 11, etc.). As such, in response to receipt of information from the computing device (e.g., electronic devices 100, 105, 110, 115, 120, 125) indicating that information is designated as private, the aggregated health summary module 78 may determine that private information may be excluded from a patient health care summary document sent to any health care entity (e.g., medical entity 1, pharmacy 3, laboratory 5, medical entity 7, pharmacy 9, laboratory 11, etc.). In an example embodiment, a patient may utilize the computing device to access (e.g., log into) a service (e.g., a website) provided by the communication device 145 and may designate medical data as public or private. As such, the aggregated health summary module 78 may exclude the data designated as private from a generated patient health care document.

In an example embodiment, the processor 34 may send a request or message to the communication device 145 requesting a patient health care document(s) for a corresponding patient(s) (e.g., John Doe). In response to receipt of the request, the communication device 145 may generate the patient health care document(s) based in part on one or more coding terminologies of medical data received by the communication device 145 from the computing device (e.g., electronic device 100). The received medical data may correspond to the particular patient(s) (e.g., John Doe). In this regard, processor 34 may receive the generated patient health care document(s) from the aggregated health summary module 78 of the communication device 145, as described more fully below.

### Exemplary System Operation

Exemplary embodiments of the invention may provide an efficient and reliable mechanism for generating one or more patient health care documents. In this regard, an exemplary embodiment may provide a communication device configured to receive discrete medical information from one or more different entities or sources (e.g., medical entity 1, pharmacy 3, laboratory 5, medical entity 7, pharmacy 9, laboratory 11, etc.). The medical information may be aggregated by the communication device and the communication device may determine that the medical information relates to one or more corresponding patients.

In response to receipt of a request from a device of a health care entity (e.g., medical entity 1), requesting a patient health care summary document corresponding to a particular patient, the communication device may, but need not, generate the patient health care summary based in part on one or more coding terminologies utilized by the requesting health care entity. Additionally, as described above, the generated patient health care summary document may exclude medical information designated as private. The communication device may send the generated patient health care summary document to the requesting health care entity. In this regard, the communication device may ensure that the device of the requesting health care entity may utilize, understand or recognize the medical information of the generated patient health care summary document. As such, an example embodiment may generate patient health care summary documents that may be unique to the health care entity requesting a patient health care document and which may exclude medical information that a patient may wish to remain private.

For purposes of illustration and not of limitation, consider an instance in which there may be three different health care entities (e.g., medical entity 1, pharmacy 3, laboratory 5) requesting patient health care summary documents related to the same patient. In this regard, a communication device may determine the coding terminology utilized by the each of the requesting health care entities and may generate three different patient health care summary documents based on the coding terminologies utilized by each of the respective requesting health care entities. The communication device may determine the coding terminologies utilized by each of the requesting health care entities based on medical information related to the patient received from by the communication device from each of the requesting health care entities.

As such, an exemplary embodiment may provide a mechanism of generating a patient health care summary document with a complete set of current medical information associated with a particular patient, with the exception of information designated as private, which may be obtained from multiple entities within a health care system. In this regard, the current medical information of the patient health care summary document may be based in part on the privacy wishes of the corresponding patient and may be coded with terminologies understood by a health care entity requesting the patient health care summary document. As such, an example embodiment may ensure that a requesting health care entity receives an accurate, complete and recognizable patient health care summary document in an efficient and reliable manner.

It should be pointed out that in an exemplary embodiment, the aggregated health summary module 78 may save the coded terminologies that one or more health care entities may send to the communication device 145 in one or more items of medical information (e.g., medication data (e.g., a medication code), diagnosis data (e.g., a diagnosis code), etc.). The aggregated health summary module 78 may save the coded terminologies to a memory (e.g., memory 86). In this regard, for example, in an instance in which a health care entity (e.g., medical entity 7) sends medical information related to a medication corresponding to a particular patient to the communication device 145 and the aggregated health summary module 78 determines that the medication is coded with a particular code (e.g., a LOINC), the aggregated health summary module 78 may save that code terminology indicating the medication along with data such as, for example, an authority identifier (ID) indicating the health care entity that the code terminology was received from. In this regard, when the health care entity that initially sent the medical information with the medication code subsequently sends a request to the communication device 145 for a patient health care summary document, the aggregated health summary module 78 may generate the patient health care summary document. In this regard, the aggregated health summary module 78 may generate the patient health care summary document and may send it to the requesting health care entity with medical data (e.g., a medication data) corresponding to each of the detected coded terminologies (e.g., a LOINC) that were previously sent to the communication device 145 by the requesting health care entity.

In this manner, the aggregated health summary module 78 may lessen the loss of fidelity. For instance, in an instance in which the aggregated health summary module 78 may generate the patient health care summary document with a coded terminology that the requesting health care entity may not recognize, there may be a loss of fidelity relating to the information corresponding to the coded terminology.

In an alternative example embodiment, one more health care entities may predetermine or predefine one or more coding terminologies that they may desire to receive for particular types of medical data (e.g., medication data, diagnosis data, laboratory data, allergy data etc). The predetermined/predefined coding terminologies assigned by the respective health care entities may be sent by an electronic device of the health care entities to the aggregated health summary module 78. In this regard, the aggregated health summary module 78 may be informed about the coding terminology preferences of the respective health care entities related to particular types of medical data prior to sending a generated patient health care summary document to the respective health care entities.

For example, the aggregated health summary module 78 may be able to determine that a health care entity desires a particular code terminology to represent medication, another code terminology to represent allergies, and a different code terminology to represent problems and diagnosis, etc. For data (e.g., results data) that the health care entities may not have specified a preferred code terminology, the aggregated health summary module 78 may provide this data in a requested patient health care summary document according to a preference of the aggregated health summary module 78 or the health care entity 12, which may correspond to a preferred coding terminology for a particular type of medical data (e.g., allergy data) related to a national standard.

In this regard, for example, for medical information received by the communication device 145 in a particular coded terminology, the aggregated health summary module 78 may send the corresponding medical information back to a requesting health care entity in a patient heath care document using the same coding terminology used by the requesting health care entity. For types of medical information (e.g., diagnosis data) in which the requesting health care entity may not have previously sent corresponding medical information (e.g., diagnosis data) to the communication device 145, the aggregated health summary module 78 may send the particular type of medical information (e.g., diagnosis data) in a patient health care summary document to the requesting health care entity according to a code terminology predefined by the requesting health care entity (e.g., a SNOMED code for diagnosis data). For all other types of medical information in which the aggregated health care module 78 may not have received from a requesting health care entity, or in which the requesting health care entity has not indicated a predefined coding terminology for the particular type(s) of medical data, the aggregated health summary module 78 may provide the particular type(s) of medical data in a patient health care summary document according a preferred coding terminology for the type of medical data. The preferred coding terminology for the particular type(s) of medical data may, but need not, be based on a national standard.

In an example embodiment, in order to enable a highest fidelity document for exchange, the aggregated health summary module 78 may generate a unique patient health care document for each health care entity that sends a request to the communication device 145. These patient health care documents may be generated with the native codes or coding terminologies of the requesting health care entity when available. However, the aggregated health summary module 78 may also be configured to update one or more health record entries of a patient health care document(s) with elements that may not be related to the native coding of the requesting health care entity.

As another example in which the aggregated health summary module 78 may generate a patient health care document, consider an example in which medical information pertaining to a medication may be received by the aggregated health summary module 78 from a first health care entity (e.g., medical entity 7). The received medication data may be related to a unique code such as, for example, an RxNorm (SCD+SBD) medication code, in which RxNorm denotes a brand name of the corresponding coding scheme, SBD denotes semantically branded drug and SCD denotes semantically clinical drug. The aggregated health summary module 78 may store the medication data sent from the first health care entity according to the native code of the health care entity which is an RxNorm (SCD+SBD) code, in this example.

On the other hand, the aggregated health summary module 78 may receive medical information from a second health care entity (e.g., pharmacy 9) associated with the same patient and the same medication. However, the medical information received from the second health care entity (e.g., pharmacy 9) may also be associated with a unique code specifying data such as Currently Taking=No, indicating that the respective patient is not currently taking the medication. Since both health care entities (e.g., medical entity 7, pharmacy 9) may be trusted health care entities, the aggregated health summary module 78 may update a record entry in a memory (e.g., memory 86) to indicate that the patient is not currently taking the medication. In an instance in which the first health care entity may request a patient health care summary from the aggregated health summary module 78, the aggregated summary module 78 may send the generated patient health care document to the first health care entity with the medication data in the same coding terminology (e.g., RxNorm (SCD+SBD codes) of first health care entity. However, the aggregated health care module 78 may also include the data obtained from the second health care entity indicating that the patient is not currently taking the medication based on the new updated entry stored in the memory (e.g., memory 86).

It should be pointed out that the aggregated health summary module 78 may determine whether one or more health care entities (e.g., medical entity 1, pharmacy 3, laboratory 5, medical entity 7, pharmacy 9, laboratory 11, etc.) are trusted health care entities based on an authority ID assigned to each of the health care entities. The aggregated health summary module 78 may utilize the authority ID to identify a health care entity and on this basis the aggregated health summary module 78 may determine whether a respective health care entity is trusted. In an example embodiment, a trusted health care entity may be verified based on an authority ID assigned to the trusted health care entity that may signify that medical information may be reconciled by one or more health care professionals of the trusted health care entity before being sent to the communication device 145. However, it should be pointed out that a trusted health care entity may be verified according to any other suitable manner.

As another example of the manner in which the aggregated health summary module 78 may generate a patient health care document, consider an instance in which the requesting health care entity (e.g., pharmacy 11) did not previously send any medical information with native codes associated with a patient to the communication device 145 or did not indicate any predefined code terminologies to the communication device. In this regard, the aggregated health summary module 78 may generate a patient health care document based on preferred coding terminologies established by the aggregated health summary module 78 or by the health care entity 12.

For example, in an instance in which a health care entity may request a patient health care document from the aggregated health summary module 78 for a patient in which the requesting health care entity did not send any medical information with native codes related to the patient to the communication device 145, the aggregated health summary module 78 may generate a patient health care document based on preferred codes assigned by the aggregated health summary module 78, or by the health care entity 12.

As another example, consider an instance in which a health care entity may request a patient health care document for a given patient from the aggregated health summary module 78. In this example, presume that the requesting health care entity previously sent the communication device 145 medical information indicating that the patient is prescribed two medications coded in a particular code terminology. Also, presume that the aggregated health summary module 78 has information indicating that the patient is actually prescribed three medications. In this regard, the aggregated health summary module 78 may generate the patient health care document with data indicating the two medications coded in the code terminology of the requesting health care entity and a third medication coded in a preferred code terminology assigned by the aggregated health summary module 78.

It should also be pointed out that in an exemplary embodiment, the aggregated health care module 78 may remove or delete some items of duplicated (also referred to herein as de-duplication) medical information received from one or more of the health care entities (e.g., medical entity 1, pharmacy 3, laboratory 5, medical entity 7, pharmacy 9, laboratory 11, etc.). For instance, the aggregated health summary module 78 may receive several items of medical information from various health care entities. Some of these items of medical information may relate to the same information but may be received from different health care entities. In this regard, the aggregated health summary module 78 may remove or delete the duplicate data from a memory (e.g., memory 86). As such, in an instance in which the aggregated health summary module 78 may generate a patient health care document, the patient health care document may include one entry corresponding to the duplicate items of medication information. In an example embodiment, the entry in the patient health care summary document may be based of the medical information received from a health care entity with a highest level of trust.

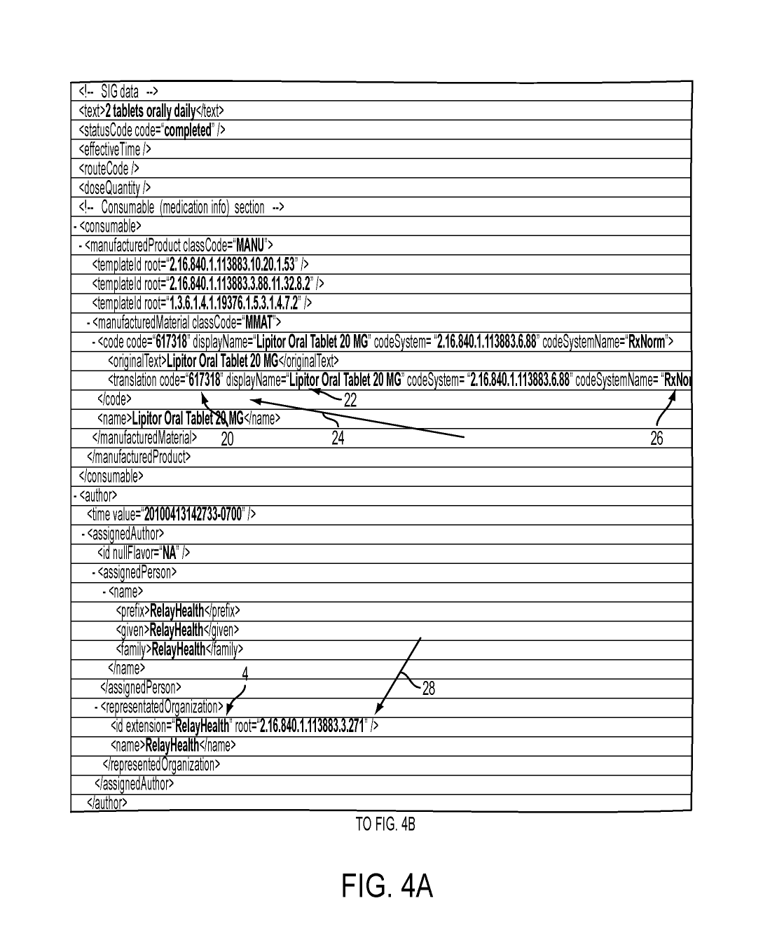

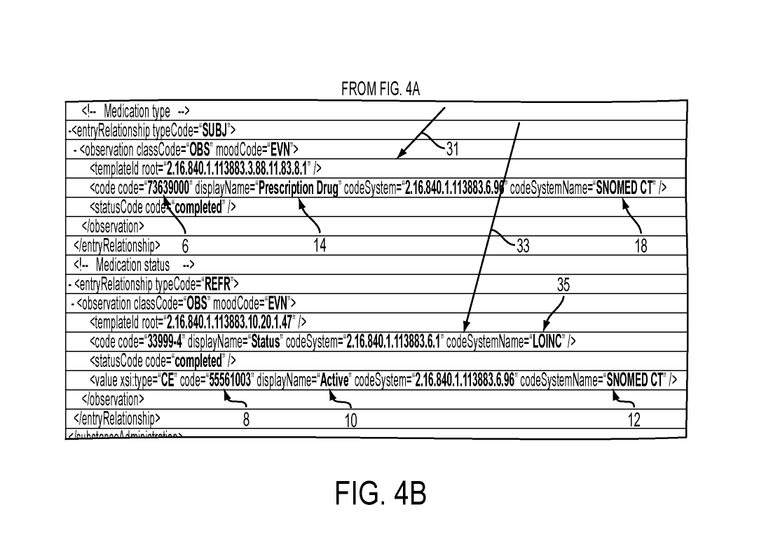

As additional examples of the manner in which the aggregated health summary module 78 may generate patient health care documents, corresponding to a respective patient, consider FIGS. 4-6 described more fully below for purposes of illustration and not of limitation.

Referring now to FIGS. 4A & 4B, an exemplary embodiment of a patient health care document according to an exemplary embodiment is provided. For purposes of illustration and not of limitation, in the example of FIGS. 4A & 4B, presume that an electronic device (e.g., electronic device 115) of a health care entity (e.g., medical entity 7) sent the communication device 145 medical information associated with a particular patient (e.g., John Doe). In this example, the medical information may include data indicating a medication (e.g., Lipotor) that the patient may be prescribed. The medication may be denoted by a unique code (e.g., medication code) in a particular coding terminology (e.g., RxNorm). In response to receipt of the medical information from the electronic device of the health care entity, the aggregated health summary module 78 may parse the data associated with the code (e.g., medication code) indicating the medication and the corresponding coding terminology along with an Authority ID indicating the identity of the health care entity and may save this parsed data in a memory (e.g., memory 86).

Presume further that the electronic device (e.g., electronic device 115) of the health care entity (e.g., medical entity 7) may subsequently send a request for a patient health care document corresponding to the patient (e.g., John Doe) to the communication device 145. The aggregated health summary module 78 may include the medication in the coded terminology (e.g., RxNorm) of the requesting health care entity for the patient in a generated patient health care document, along with other data. As such, the aggregated health care summary module 78 may send the generated patient health care document to an electronic device (e.g., electronic device 115) of the requesting health care entity (e.g., medical entity 7).

For instance, as shown in the exemplary embodiment of the patient health care document of FIGS. 4A & 4B, the aggregated health summary module 78 may generate the patient health care document data 24 associated with the medication code 20 (e.g., 617318), relating to an indication 22 of the medication (e.g., Lipitor Oral Tablet 20 MG), in the code terminology 26 (e.g., RxNorm) utilized by the requesting health care entity. (See e.g., FIG. 4A) Additionally, as shown in the example embodiment of the patient health care document of the FIGS. 4A & 4B, for other medical information in which the aggregated health summary module 78 may not have received medical data with one or more native codes, or an indication of predefined coding terminologies for particular types of medical data, from the requesting health care entity, the aggregated health summary module 78 may generate this medical data (e.g., items of medical data 28, 31, 33) utilizing preferred coding terminologies of the aggregated health summary module 78 or a health care entity (e.g., heath care entity 12 (e.g., Relay Health™) maintaining the aggregated health summary module 78. For example, the aggregated health summary module 78 may indicate that some data 4 may be generated based on coding terminologies of the health care entity (e.g., heath care entity 12 (e.g., Relay Health™)) associated with or maintaining the aggregated health summary module 78.

For instance, the aggregated health summary module 78 may determine that a memory (e.g., memory 86) of the communication device 145 may store other medical data, such as, for example, medication data associated with the patient in a code terminology assigned by the aggregated health summary module 78 or preferred by the health care entity maintaining the aggregated health summary module 78. The medication data may also indicate whether the patient is currently or actively taking the medication. For example, in the example embodiment of FIGS. 4A & 4B, the medication data may indicate that the patient is actively taking the medication. In this regard, for example, the aggregated health summary module 78 may include the medication data 6 (e.g., medication code (e.g., 73639000)), relating to an indication 14 (e.g., Prescription Drug) of the medication, in the coded terminology 18 (e.g., SNOMED) assigned by the aggregated health summary module 78 in the generated patient health care document. (See e.g., FIG. 4B).

Additionally, the aggregated health summary module 78 may include data 8 (e.g., a code (e.g., 55561003)) relating to an indication 10 (e.g., text “Active”) of the status that the patient is actively taking the medication in the corresponding code terminology 12 (e.g., SNOMED) assigned by the aggregated health summary module 78 in the generated patient health care document. (See e.g., FIG. 4B) It should also be pointed out that the aggregated health summary module 78 may generate other data in other coding terminologies 35 (e.g., a LOINC) assigned by the aggregated health summary module 78. (See e.g., FIG. 4B)

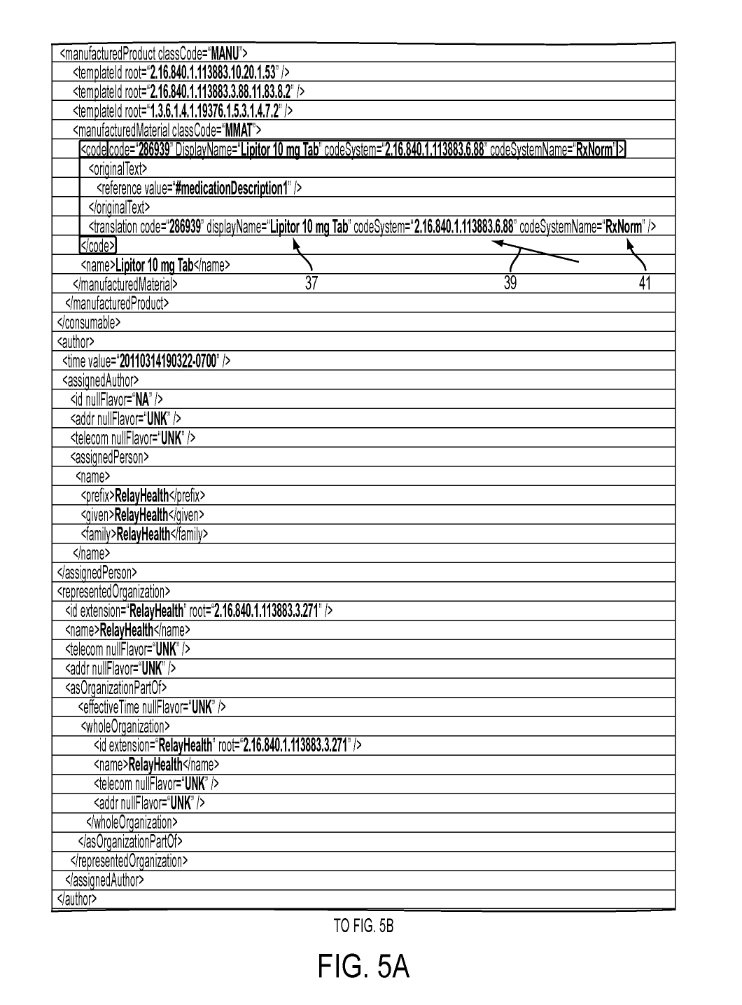

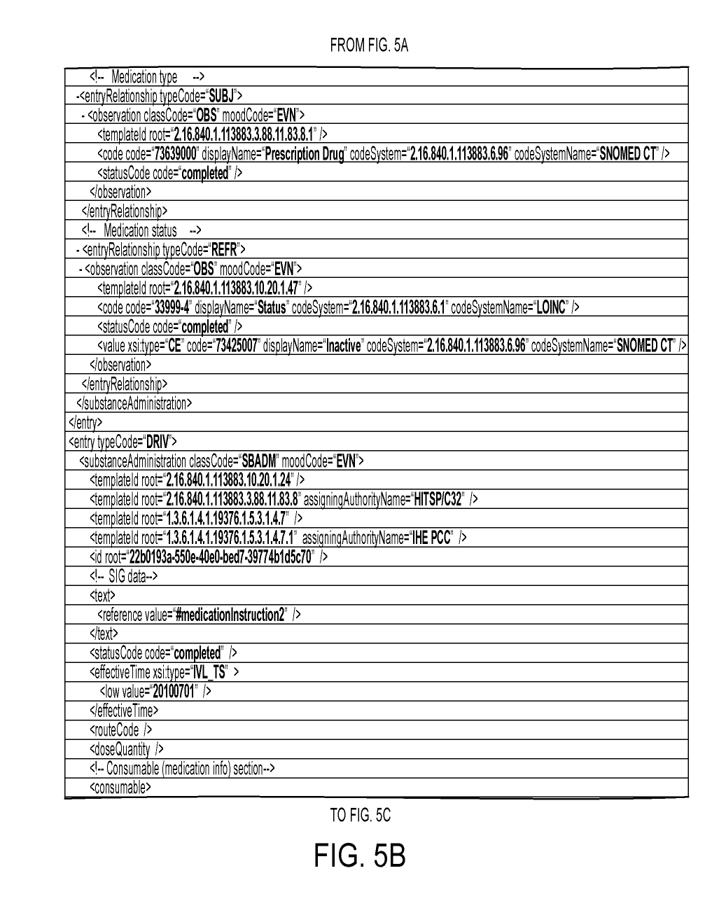

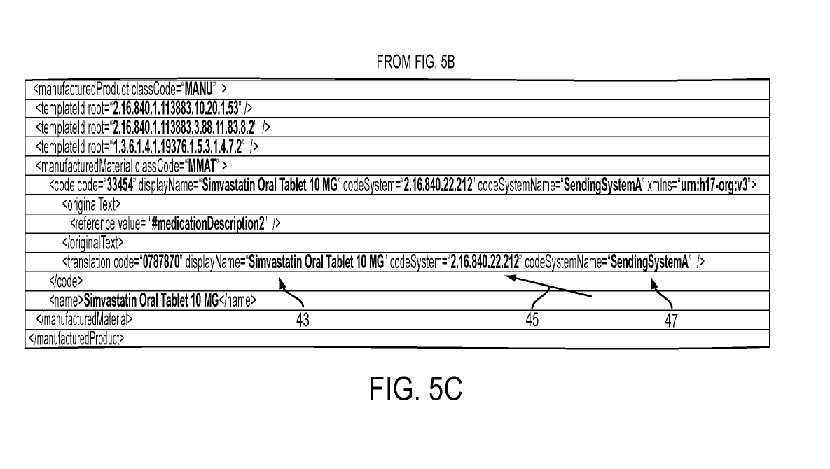

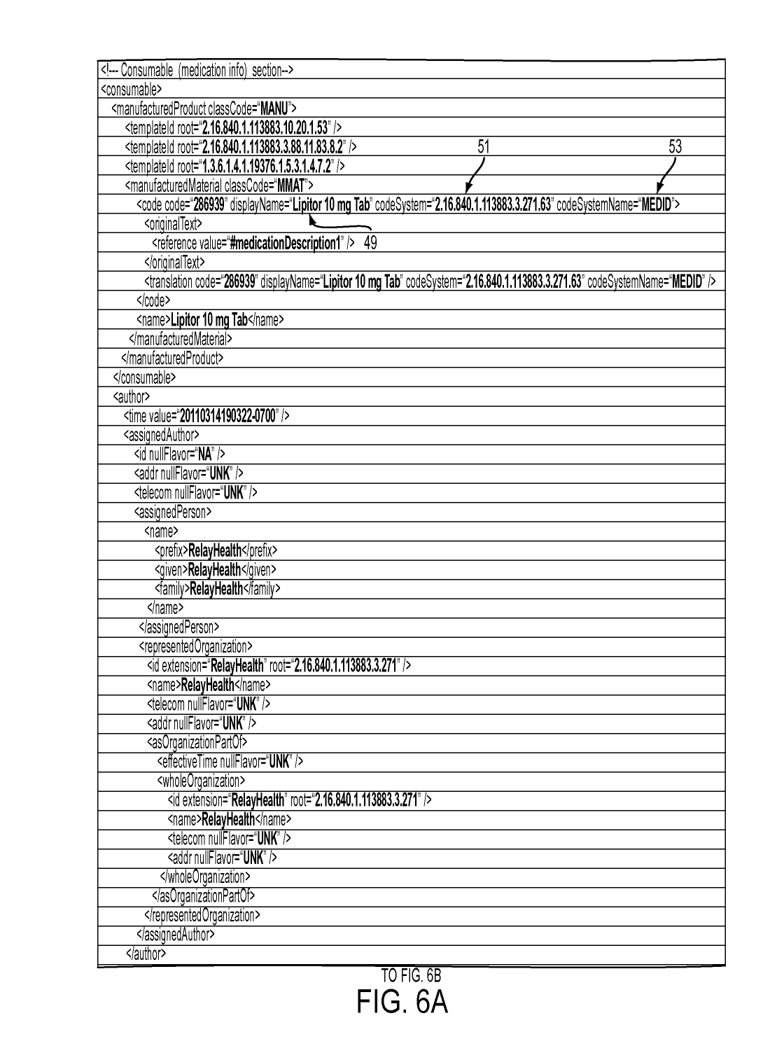

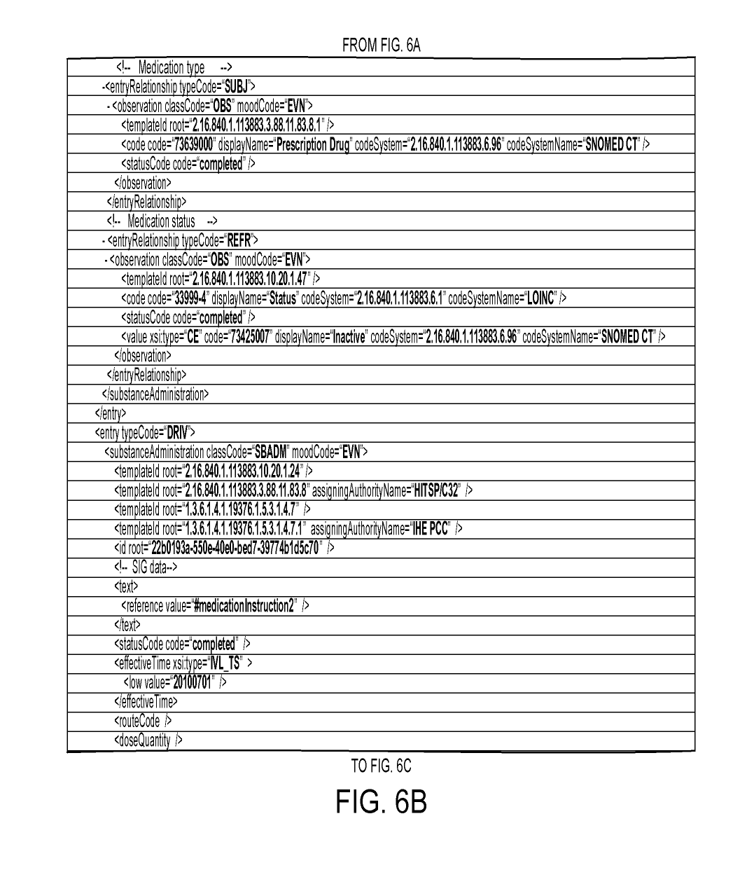

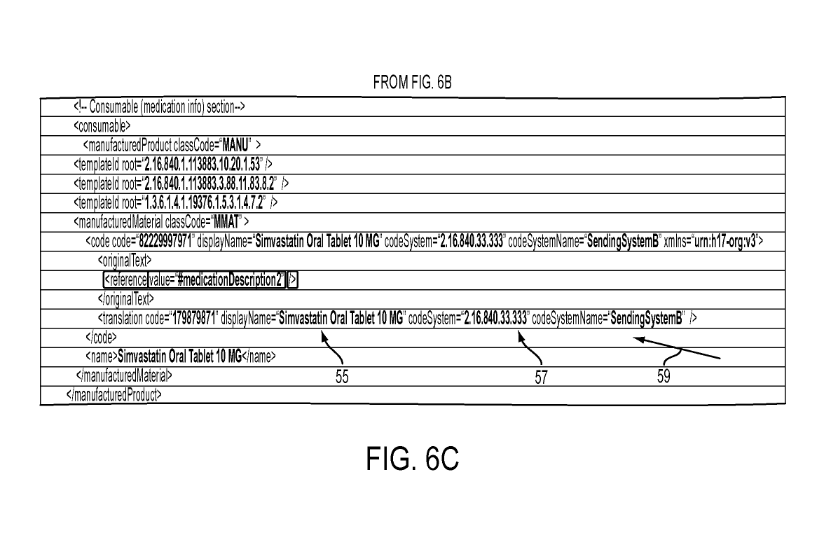

Referring now to FIGS. 5A, 5B, 5C, 6A, 6B and 6C, diagrams of patient health care documents according to an exemplary embodiment are provided. In the example embodiment of FIGS. 5A, 5B, 5C, 6A, 6B and 6C, an electronic device (e.g., electronic device 100) of a first health care entity (e.g., medical entity 1) may provide the aggregated health summary module 78 with an indication that its predefined code terminology for medications may include RxNorm codes. In response to the receipt of the indication, the aggregated health summary module 78 may store the predefined code terminology (e.g., RxNorm codes) in a memory (e.g., memory 86) as the preferred medication code terminology for the first health care entity. In addition, an electronic device (e.g., electronic device 115) of a second health care entity (e.g., medical entity 7) may provide the aggregated health summary module 78 with an indication that its predefined code terminology for medications may include First Data Bank (FDB) MEDID codes in which a MEDID may be the FDB identifier for a drug(s). In response to the receipt of the indication, the aggregated health summary module 78 may store the predefined code terminology (e.g., FDB MEDID codes) in a memory (e.g., memory 86) as the preferred code terminology for the second health care entity.

In the example embodiments of FIGS. 5A, 5B, 5C, 6A, 6B and 6C, presume that the electronic device of the first health care entity may be a trusted health care entity and may send medical information to the communication device 145. The medical information sent to the communication device 145 may indicate that a patient (e.g., John Doe) is prescribed a medication such as, for example, Lipitor coded with a code that the aggregated health summary module 78 may recognize and a medication such as, for example, Simvastatin with a code that aggregated health summary module 78 may not recognize Also, presume that the electronic device of the second health care entity may be a trusted health care entity and may send medical information to the communication device 145. The medical information sent to the communication device 145 may indicate that the patient (e.g., John Doe) is prescribed Lipitor coded with a code that the aggregated health summary module 78 may recognize and Simvastatin with a code that the aggregated health summary module 78 may not recognize.

Presume further that the electronic device of the first health care entity may send the aggregated health summary module 78 a request for a patient health care document corresponding to a respective patient (e.g., patient John Doe). Additionally, presume that the electronic device of the second health care entity may send the aggregated health summary module 78 a request for a patient health care document corresponding to the same respective patient (e.g., patient John Doe).

In this regard, as shown in FIGS. 5A, 5B and 5C the aggregated health summary module 78 may generate a patient health care document for the first health care entity that includes medical information such as, for example, medication data 37 for Lipitor coded 39 with RxNorm 41, (See e.g., FIG. 5A) as per the preference identified by the first health care entity, and medication data 43 for Simvastatin coded 45 with the medication code 47 that the first health care entity (also referred to herein as Sending System A) initially sent the communication device 145 for Simvastatin. (See e.g., FIG. 5C) In addition, as shown in FIGS. 6A, 6B and 6C, the aggregated health summary module 78 may generate a patient health care document for the second health care entity that includes medical information such as, for example, medication data 49 for Lipitor coded 51 with FDB MEDID 53 (See e.g., FIG. 6A), as per the preference identified by the second health care entity, and medication data 55 for Simvastatin coded 57 with the medication code 59 that the second health care entity (also referred to herein as Sending System B) initially sent the communication device 145 for Simvastatin. (See e.g., FIG. 6C)

In this regard, the aggregated health summary module 78 may be configured to populate each of the patient health care documents of FIGS. 5A, 5B, 5C, 6A, 6B and 6C with medical information corresponding to the codes of the first health care entity and the second health care entity in instances in which the aggregated health summary module 78 may not recognize the codes. Additionally, the aggregated health summary module 78 may be configured to populate the patient health care documents with medical information corresponding to the desired coding terminologies of the first health care entity and the second health care entity.

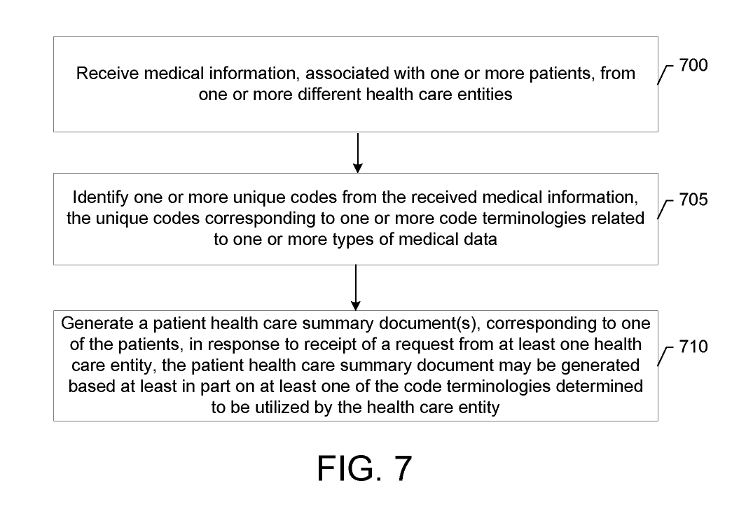

Referring now to FIG. 7, an exemplary method for generating one or more patient health care summary documents according to an exemplary embodiment is provided. At operation 700, an apparatus (e.g., aggregated health summary module 78) may receive medical information, associated with one or more patients, from one or more different health care entities (e.g., medical entity 1, pharmacy 3, laboratory 5, medical entity 7, pharmacy 9, laboratory 11, etc). In an example embodiment, one or more electronic devices (e.g., electronic devices 100, 105, 110, 115, 120, 125) of the health care entities may send the medical information to the apparatus.

At operation 705, the apparatus (e.g., aggregated health summary module 78) may identify one or more unique codes from the received medical information. The unique codes (e.g., SNOMED codes, LOINC codes, ICD-9 codes, etc.) may correspond to one or more code terminologies related to one or more types of medical data (e.g., medication data, diagnosis data, laboratory data, etc.). At operation 710, the apparatus may generate at least one patient health care summary document, corresponding to one of the patients, in response to receipt of a request from the health care entity. The patient health care summary document may be generated based at least in part on at least one of the code terminologies determined to be utilized by the health care entity.

It should be pointed out that FIG. 7 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86, memory 36) and executed by a processor (e.g., processor 70, processor 34, aggregated health summary module 78). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the methods of FIG. 7 above may comprise a processor (e.g., the processor 70, the processor 34, the aggregated health summary module 78) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 34, the processor 70 (e.g., as means for performing any of the operations described above), the aggregated health summary module 78 and/or a device or circuit for executing instructions or executing an algorithm for processing information as described above.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving medical information, associated with one or more patients, from one or more different health care entities;
identifying one or more unique codes from the received medical information, the unique codes corresponding to one or more code terminologies related to one or more types of medical data; and
generating, via a processor, at least one patient health care summary document, corresponding to a patient, in response to receipt of a request from at least one of the health care entities, the patient health care summary document is generated based in part on at least one of the code terminologies determined to be utilized by the at least one health care entity.

2. The method of claim 1, wherein generating the patient health care summary document further comprises excluding one or more items of the received medical information designated as private from the generated patient health care summary document.

3. The method of claim 1, further comprising, determining the at least one code terminology utilized by the at least one health care entity based in part on one or more items of the received medical information being coded with the at least one code terminology.

4. The method of claim 1, wherein the patient health care summary document comprises a continuity of care document.

5. The method of claim 1, further comprising determining that the patient or the one or more of the health care entities designated the items of received medical information as private.

6. The method of claim 1, further comprising:
receiving another request for another patient health care document, corresponding to the patient, from another health care entity of the entities; and
generating the another patient health care summary document in response to receipt of the another request based in part on at least one different code terminology, of the code terminologies, determined to be utilized by the another health care entity.

7. The method of claim 1, further comprising:
receiving an indication of at least one predefined selection of a code terminology to utilize for at least one type of medical content on behalf of the at least one health care entity, wherein
generating further comprises generating the patient health care summary document based in part on the predefined code terminology for the type of medical content.

8. The method of claim 1, wherein the coding terminologies comprises at least one of a Systematized Nomenclature of Medicine (SNOMED) code terminology, a Logical Observation Identifiers Names and Code (LOINC) code terminology, or an International Statistical Classification of Diseases and Related Health Problems 9 (ICD-9) code terminology.

9. An apparatus comprising:
at least one memory; and
at least one processor configured to cause the apparatus to:
receive medical information, associated with one or more patients, from one or more different health care entities;
identify one or more unique codes from the received medical information, the unique codes corresponding to one or more code terminologies related to one or more types of medical data; and
generate at least one patient health care summary document, corresponding to a patient, in response to receipt of a request from at least one of the health care entities, the patient health care summary document is generated based in part on at least one of the code terminologies determined to be utilized by the at least one health care entity.

10. The apparatus of claim 9, wherein the processor is further configured to cause the apparatus to:
generate the patient health care summary document by excluding one or more items of the received medical information designated as private from the generated patient health care summary document.

11. The apparatus of claim 9, wherein the processor is further configured to cause the apparatus to:
determine the at least one code terminology utilized by the at least one health care entity based in part on one or more items of the received medical information being coded with the at least one code terminology.

12. The apparatus of claim 9, wherein the patient health care summary document comprises a continuity of care document.

13. The apparatus of claim 9, wherein the processor is further configured to cause the apparatus to:
determine that the patient or the one or more of the health care entities designated the items of received medical information as private.

14. The apparatus of claim 9, wherein the processor is further configured to cause the apparatus to:
receive another request for another patient health care document, corresponding to the patient, from another health care entity of the entities; and
generate the another patient health care summary document in response to receipt of the another request based in part on at least one different code terminology, of the code terminologies, determined to be utilized by the another health care entity.

15. The apparatus of claim 9, wherein the processor is further configured to cause the apparatus to:
receive an indication of at least one predefined selection of a code terminology to utilize for at least one type of medical content on behalf of the at least one health care entity, wherein
generate the patient health care summary document further comprises generating the patient health care summary document based in part on the predefined code terminology for the type of medical content.

16. The apparatus of claim 9, wherein the coding terminologies comprises at least one of a Systematized Nomenclature of Medicine (SNOMED) code terminology, a Logical Observation Identifiers Names and Code (LOINC) code terminology, or an International Statistical Classification of Diseases and Related Health Problems 9 (ICD-9) code terminology.

17. A computer program product comprising at least one computer-readable storage medium having computer-executable program code instructions stored therein, the computer executable program code instructions comprising:
program code instructions configured to facilitate receipt of medical information, associated with one or more patients, from one or more different health care entities;
program code instructions configured to identify one or more unique codes from the received medical information, the unique codes corresponding to one or more code terminologies related to one or more types of medical data; and
program code instructions configured to generate at least one patient health care summary document, corresponding to a patient, in response to receipt of a request from at least one of the health care entities, the patient health care summary document is generated based in part on at least one of the code terminologies determined to be utilized by the at least one health care entity.

18. The computer program product of claim 17, wherein generate the patient health care summary document further comprises excluding one or more items of the received medical information designated as private from the generated patient health care summary document.

19. The computer program product of claim 17, further comprising:
program code instructions configured to determine the at least one code terminology utilized by the at least one health care entity based in part on one or more items of the received medical information being coded with the at least one code terminology.

20. The computer program product of claim 17, further comprising:
program code instructions configured to determine that the patient or the one or more of the health care entities designated the items of received medical information as private.
